(19) United States
(12) Patent Application Publication
(10) Pub. No.: US 2011/0047052 A1
(43) Pub. Date: Feb. 24, 2011

(54) Method and process for an energy management system for setting and adjusting a minimum energy reserve for a rechargeable energy storage device

(76) Inventor: Kevin Terrill Cornish, Berkeley, CA (US)

Correspondence Address: Paul M. Denk, Suite 305, 763 S. New Ballas Road, St. Louis, MO, 63141, US

(21) Appl. No.: 12/806,368

(22) Filed: Aug. 11, 2010

Related U.S. Application Data
(60) Provisional application No. 61/234,997, filed on Aug. 18, 2009.

(51) Int. Cl. G06Q 10/00; G06F 1/26; H02J 7/00; G01C 21/00; G06Q 40/00

(52) U.S. Cl. 705/30; 700/291; 320/128; 320/136; 701/200; 705/37

(57) ABSTRACT

An energy management system which will allow the owner to set a minimum energy reserve or charge for an energy storage device (ESD), such ESD being coupled to an asset that is further connected to the electric utility grid. A plurality of sensors may be utilized to provide data, including ESD health and ambient conditions, so that, along with other owner data inputs and profile information, an appropriate amount of energy may be charged to and maintained in the ESD to enable the associated asset to perform anticipated tasks. The energy management system may be either directly or remotely programmed via secure communications, and will further provide the owner with the ability to discharge energy back to the grid during demand events, or to discharge to other owner specified assets, at the owner's discretion.

### CROSS REFERENCE TO RELATED APPLICATION

This non provisional patent application claims priority to the provisional patent application having Ser. No. 61/234,997, having filing date Aug. 18, 2009.

### FIELD OF THE INVENTION

The present invention relates to an energy management system used (a) to determine the minimum level of energy that must be stored in an energy storage device (e.g., a battery or fuel cell) in order for the associated asset to perform desired tasks (b) to adjust the minimum level of stored energy based upon revisions to tasks (c) to determine the amount of energy available for discharge for purposes other than desired tasks and (d) in association with a database, to (i) aggregate the load requirements of “n” number of assets that are engaged on a given circuit or feeder of an electric utility's grid infrastructure and (ii) to aggregate the energy available for discharge to the electric utility's grid infrastructure (either directly or indirectly through a larger energy storage device) from “n” number of assets that are engaged on a given feeder circuit, and where “n” is any number greater than 1.

### INTRODUCTION AND BACKGROUND OF THE INVENTION

The American Recovery and Reinvestment Act of 2009 (the “ARRA”) appropriated funds towards the development and deployment of intelligent electric utility infrastructure projects throughout the United States, commonly referred to as “Smart Grid” projects. It is expected that the Smart Grid will eventually proliferate, and will be characterized by advanced communications systems that link grid assets with head end software systems, allowing remote and real time monitoring and control of such grid assets. Furthermore, it is envisioned that the Smart Grid should enable utility companies (or grid operators) to communicate directly with consumers of electricity, and potentially remotely engage or disengage equipment, if a capable Home Area Network (“HAN”) or a Commercial Area Network (“CAN”) has been installed. In conjunction with passage of the ARRA, the U.S. Department of Energy (the “DOE”) has been tasked with developing a framework of standards to be employed in the development of the Smart Grid. The DOE, in turn, has tapped the National Institute of Standards and Technology (“NIST”) to recommend a body of relevant standards that should apply to the Smart Grid. In assessing the body of standards work that could apply to the U.S. Smart Grid, NIST has selected the Electric Power Research Institute (EPRI) to assist in the development of a standards roadmap for development of the Smart Grid.ⁱ

The envisioned Smart Grid will be able to transmit and distribute electricity generated by not only conventional power plants (fueled by coal, oil, natural gas or nuclear plants) but also by plants or farms that are characterized as renewable sources of energy (based on solar, wind, hydro, thermal or wave resources). In addition, energy will be made available to the grid from commercial or residential generation sets, smaller scale renewable energy systems, or from Energy Storage Devices such as fuel cells or battery banks. The commercial or residential level generating assets that are expected to be capable of providing energy to the grid are commonly referred to as “Distributed Generation” assets. Energy Storage Devices are not generating assets, per se, but instead are more appropriately viewed as containers to hold generated energy until such time as there is a purpose to extract the stored energy.

Energy Storage Devices have a primary purpose of providing energy to satisfy a particular need such as powering appliances, machinery or equipment. These Energy Storage Devices may also, in concept, serve an ancillary purpose of providing stability to the electric grid infrastructure during times of peak demand or system stress. For example, the Energy Storage Devices mounted within a plug-in hybrid electric vehicle (PHEV) or a plug-in electric vehicle (EV) has as its primary purpose the provision of electricity to enable the propulsion of the vehicle, while a secondary purpose of the Energy Storage Device might be to power home appliances during power outages or high tariff periods, and a tertiary purpose might be to offer power to the grid to assist in stability of the Smart Grid or to possibly profit from selling energy to the grid during high tariff periods—in essence, energy arbitrage.

At present, the focus of the efforts by EPRI, NIST and the DOE in developing Smart Grid standards has been to view all sources of energy as a “node” on the Smart Grid. The Smart Grid, according to the U.S. Government initiatives, should be able to provide or extract energy according to its needs, with the primary objective being one of grid stability. This approach, however, falls short of meeting societal needs if energy is extracted from Energy Storage Devices to a degree that they are no longer capable of serving their primary function (e.g., providing energy to equipment, appliances or PHEVs).

### DESCRIPTION OF THE RELATED ART

The current state of the art with respect to the Smart Grid's ability to engage Energy Storage Devices is flawed in that it does not provide the owner/operator of the Energy Storage Device with complete control over the charging and discharging of the device. Complete control includes the ability of the owner/operator to alter its decision (whether to charge or discharge) at any point in time (whether during time of peak demand on the Smart Grid, or not) (FIG. 1).

Further, the current state of the art with respect to Energy Management Systems is flawed, in that they do not allow the consumer to exercise the needed dynamic control over the minimum level of charge that is desired by the consumer.

Energy Management Systems currently in existence, or described in existing patents, published applications or other prior art, do not provide for a system or method of balancing the complexities that will be placed on Energy Storage Devices in the future. In particular, the current state of the art fails to protect the owner/operator of the Energy Storage Device by allowing the consumer to establish a minimum reserve that should be maintained in the device, which will not be available for extraction to the Smart Grid. See FIG. 1.

The Energy Management Systems must also be able to communicate with the consumer while the consumer is present at a location outside of the service territory that is engaged with the charging or discharging of the Energy Storage Device (see FIG. 2). The envisioned usage of a utility AMI system, allowing communications to occur only between a utility and the Energy Storage Device, is a weakness. In addition, in the case of a mobile Energy Storage Device, the Energy Management System should function to allow a consumer to control the energy charging from or discharging to the Smart Grid irrespective of the utility service territory wherein the device is located.

### CURRENT STATE OF THE ART

Energy Storage Devices may be classified into two separate categories: (1) mobile and (2) fixed. Mobile units are the more challenging category with respect to Energy Management Devices, and include the battery banks commonly found in electric vehicles (EVs) and plug-in hybrid electric vehicles (PHEVs). Fixed battery banks have also become commercially available, and while typically serving as a source of backup power for both commercial and residential applications (in the event of an interruption in the availability of primary electricity service), they may also operate as an intermediary device that passes energy from renewable generating assets on to primary use equipment. The largest battery bank connected to the US grid has a rated capacity of 26 MWHⁱⁱ (nearly enough to power 3 average US homes for a year).

Energy Storage Devices are important to the functionality of vehicles—electric vehicles in particular. From historical accounts, the first commercial production of EVs occurred in 1897 when the Electric Carriage & Wagon Company of Philadelphia built a fleet of New York taxis. While EVs enjoyed some popularity around the turn of the century, their high cost and low top speeds compared to later internal combustion vehicles resulted in a significant decline in their production. A resurgence of EVs occurred in 1976, as the U.S. faced petroleum supply constraints, and the Energy Research and Development Association launched a federal program for the development of electric and hybrid vehicles. Political and economic conditions in the early 1980s caused a waning of interest in the development of electric and hybrid vehicles. Low oil prices continued to effectively mute significant progress in electric vehicle drive trains and EV/PHEV specific Energy Storage Devices until the more recent petroleum price shocks at the turn of the 21^{st} century. Within the past few years, PHEVs have become popular, as both consumers and manufacturers are investing in the technology. Today's PHEVs include Energy Storage Devices and Energy Management Systems that have evolved over the last 100 years but, by all accounts, the devices and systems remain in their infancy.

Within the field of Energy Management Systems, the use of sensors to detect ambient conditions that affect the characteristics of Rechargeable Energy Storage Devices has recently been introduced as a tool to govern charging regimes. Temperature sensors have been employed as a means to optimize the charge placed upon a battery, or single cells within a battery, and also as an approach to control the discharge of a battery so as not to accelerate deterioration of the batteryⁱⁱⁱ. Other methods of conserving the life of Energy Storage Devices include establishing an upper and lower band of charge/discharge at room temperature.^{iv}

There are yet other configurations of Energy Management Systems that monitor voltage and attempt to optimize the flow and management of energy to loads, in an effort to more accurately control and predict battery charge and discharge^{v}, or to disengage “non-essential” loads in a hierarchal manner in response to critical state of charge (SOC) signals.^{vi} Systems have also been devised for monitoring the health of an Energy Storage Device by applying a load and assessing both voltage and current responses^{vii}.

General Motors (GM) has developed methods for determining the SOC of a battery system, including one based upon an equivalent circuit approach using least squares regression means^{viii}, and another based upon calculations of open circuit voltage measuring both during and after operation^{ix}. These methods are specifically applicable to their development of PHEV energy management systems.

GM has also devised a sophisticated “Predictive energy management system for hybrid electric vehicles”^{x}, wherein a plurality of discrete inputs are utilized to determine the optimum mix of engaging the PHEV's combustion engine and its electric motor. The energy management system strives to maintain the battery SOC at or near a nominal value.

In addition to assessment of the SOC of vehicle batteries, GM has produced a number of disclosures that might apply to potential interoperability of PHEVs with the Smart Grid. A GM presentation at North Carolina State University's “Plug-in 2008 Conference”^{xi}, discussing the Challenges for Plug in Electric Vehicle Infrastructure, describes a complex Smart Grid system design that includes two-way communications with significant interaction and control by utility companies over time slotting of charging PHEVs.

The GM presentation, developed in collaboration with EPRI, appears to capture the current state of the art with respect to the interaction of PHEVs with the Smart Grid, albeit, based on theories and disclosures that are not currently practiced in the real world.^{xii}

Finally, on Jun. 18, 2009, NIST released its Report on Smart Grid Standards (as delivered by EPRI)^{xiii}, which describes in detail the developments to date and related considerations that should apply to the Smart Grid. There have been many disclosures and publications devoted to developing a Smart Grid that is capable of both providing and extracting electricity to/from Energy Storage Devices, depending upon the supply and demand on the grid, with emphasis placed on the Smart Grid's utilization of energy from Distributed Generation to provide needed power during times of peak demand. While the format differs from the GM/EPRI presentation, the context of the message is fairly consistent.

### PROBLEMS WITH CURRENT STATE OF THE ART

The US hopes to accomplish many goals from its investment in the Smart Grid, including real time feedback of grid operations, automation wherever possible, and inclusion of environmentally friendly sources of electric generation. Ultimately, however, the primary goal should be to balance the supply of electricity produced with the demand of electricity consumed; otherwise, waste occurs. Unlike other commodities, electricity must be consumed almost immediately after it is created. Electricity needs to be in a constant balance between supply (generation) and demand (consumption). This dynamic requires the electric industry to be on constant standby to generate an amount that is slightly greater than the maximum amount that all consumers could at once demand at any given time—accounting for grid losses and emergencies. Energy

Storage Devices can be engaged to absorb some amount of the excess capacity, when available, and can be called upon to deliver energy during times of peak demand.

Energy Storage Devices, as contemplated by GM, EPRI, NIST and the DOE, should be made available in support of the Smart Grid to balance electricity supply and demand and to stabilize the QOS aspect of electricity delivery—based upon the needs of the Smart Grid—not the consumer (i.e., the true owner/intended operator of the Energy Storage Device).

For example, a commercial or industrial entity may purchase an Energy Storage Device (a battery bank) as backup power for a computer network. The entity will purchase power from the electric utility to charge the ESD. Assume that a demand event occurs, and that the utility decides to draw power from the ESD to stabilize the grid. Assume further that the ESD is drawn down to its lower limit (so that it can no longer provide power without being damaged). Finally, assume that the demand event cannot be corrected, and so a brown-out event occurs. In this case, the entity had invested funds in a capital asset designed to support its business, only to have the utility exhaust the usefulness of its asset, and the entity is thereby harmed from a business operations perspective.

When applying the current state of the art to EVs or PHEVs, a similar result may occur. The vehicle owner/operator will expect a level of performance that may not be available if a utility service provider has the ability to withdraw power from the Energy Storage Device without regards for the user's requirements.

The current state of the art with respect to the Smart Grid's ability to engage Energy Storage Devices is flawed in that it does not provide the owner/operator of the Energy Storage Device with complete control over the charging and discharging of the device. Complete control includes the ability of the owner/operator to alter its decision (whether to charge or discharge) at any point in time (whether during time of peak demand on the Smart Grid, or not). Further, the current state of the art with respect to Energy Management Systems is flawed, in that they do not allow the consumer to exercise the needed dynamic control over the minimum level of charge that is desired by the consumer.

Energy Management Systems currently in existence, or described in existing patents, published applications or other prior art, do not provide for a system or method of balancing the complexities that will be placed on Energy Storage Devices in the future. In particular, the current state of the art fails to protect the owner/operator of the Energy Storage Device by allowing the consumer to establish a minimum reserve that should be maintained in the device, which will not be available for extraction to the Smart Grid.

The Energy Management Systems must also be able to communicate with the consumer while the consumer is present at a location outside of the service territory that is engaged with the charging or discharging of the Energy Storage Device. The envisioned usage of a utility AMI system, allowing communications to occur only between a utility and the Energy Storage Device, is a weakness. In addition, in the case of a mobile Energy Storage Device, the Energy Management System should function to allow a consumer to control the energy charging from or discharging to the Smart Grid irrespective of the utility service territory wherein the device is located.

### SUMMARY OF THE INVENTION

Energy management systems, to date, have been devised to maximize the performance of the underlying energy storage device. For example, U.S. Pat. No. 7,514,905 to Kawahara, et al, describes a battery management system to achieve optimal charge or discharge control in a state where individual battery cells are simultaneously experiencing variations in temperature. Previously disclosed energy management systems, while perhaps useful in maximizing the performance of an energy storage device, fail to consider the impact that third party actors may have on the overall state of charge of the energy storage device. It is expected that both (a) energy consumers and (b) energy providers will desire the capability to exert some degree of control over timing of charging and/or discharging of energy to or from an energy storage device to achieve a balance on the electric grid of supply and demand. The U.S. Government, in conjunction with utility companies throughout the United States, is investing billions of dollars in infrastructure to enable a balancing of energy supply and demand (the Smart Grid) to curtail waste and to minimize emissions of pollutants into the atmosphere.

Consumers are expected to willingly cooperate with the U.S. Government and the electric energy providers to minimize waste and emissions, as long as they are not unduly inconvenienced by the process.

As this is a ground breaking initiative, there is no operational system for that can be viewed as Current State of the Art for the Smart Grid. The art that has been disclosed to date (as described below) provides insights into the interoperability requirements of Energy Storage Devices with the much anticipated Smart Grid. It is expected that the complete solution will require an end to end solution that includes:
1. A robust Energy Management System that is capable of
   a. Independently performing algorithmic calculations, based upon sensor and database inputs, to determine necessary storage levels for the Energy Storage Device
   b. Two way communications
   c. Interfacing with and sending instructions to an AC to DC/DC to AC inverter or controller (whether independent or combined equipment) that enables energy flow in either direction
   d. Accepting or declining a charge of energy from the Smart Grid based upon pricing schemes
   e. Accepting or declining a request from the Smart Grid for extraction of power from the Energy Storage Device;
2. A robust central database, with independent algorithmic calculation capabilities, that hosts inputs from and outputs to:
   a. Energy Storage Devices
   b. Primary Electric Service Providers (Retailers, Independent System Operators, et. al.)
   c. Consumers/Owners/Operators of Energy Storage Devices
   d. Authorized Third Parties; and
3. Authorized access to the Energy Management System from remote locations to:
   a. Provide revised instructions that may affect the required store of energy
   b. Alter the ESD charging schedule
   c. Perform other essential tasks as may be necessary (e.g., firmware updates, etc.)

These and other objects may become more apparent to those skilled in the art upon review of the invention as described herein, and upon undertaking a study of the description of its preferred embodiment, when viewed in conjunction with the drawings.

### BRIEF DESCRIPTION OF THE DRAWINGS

In referring to the drawings,

FIG. 1 shows the System Utility/Consumer Interaction Diagram;

FIG. 2 shows the System Data Flow and Consumer Interaction Diagram for different geographic locations;

FIG. 3 shows the System Overview and Utilization of Multiple Communications Methods;

FIG. 4 shows the System Block Diagram including Inputs, Outputs, Database(s) interaction and User Interface for the determination of Energy control (purchasing or the selling of power) based upon he operators need at any given point in time or cost constraints; and

FIG. 5 shows the User Interface illustrating the ability to use simple slide rules to adjust the price the owner-operator is willing to sell or buy energy for.

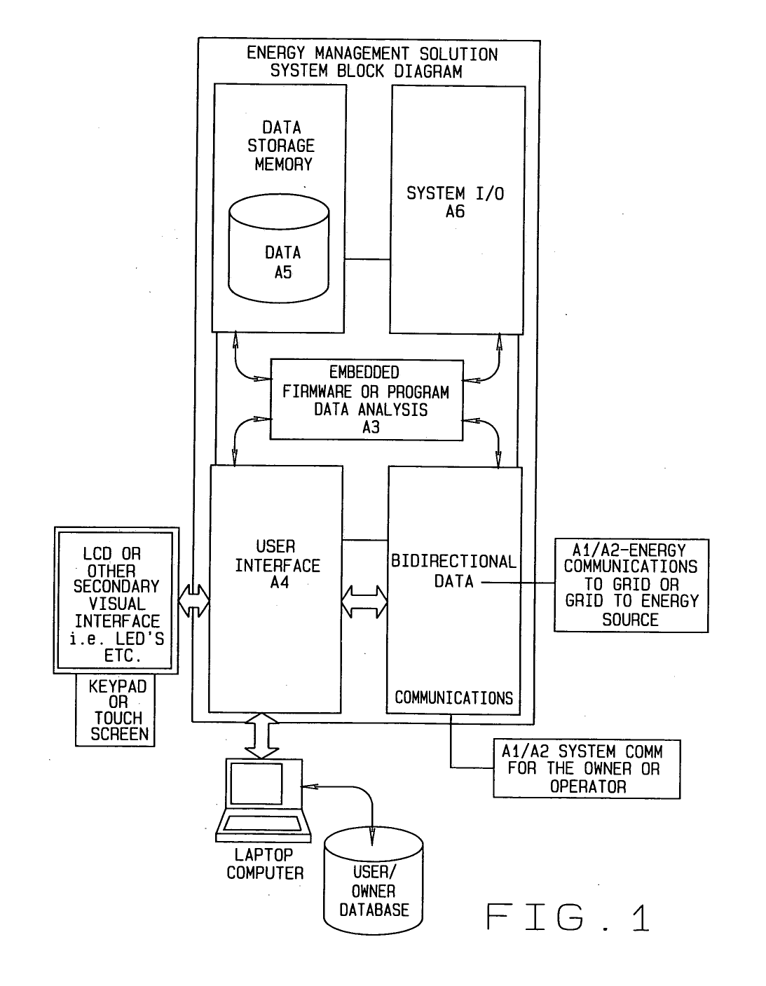

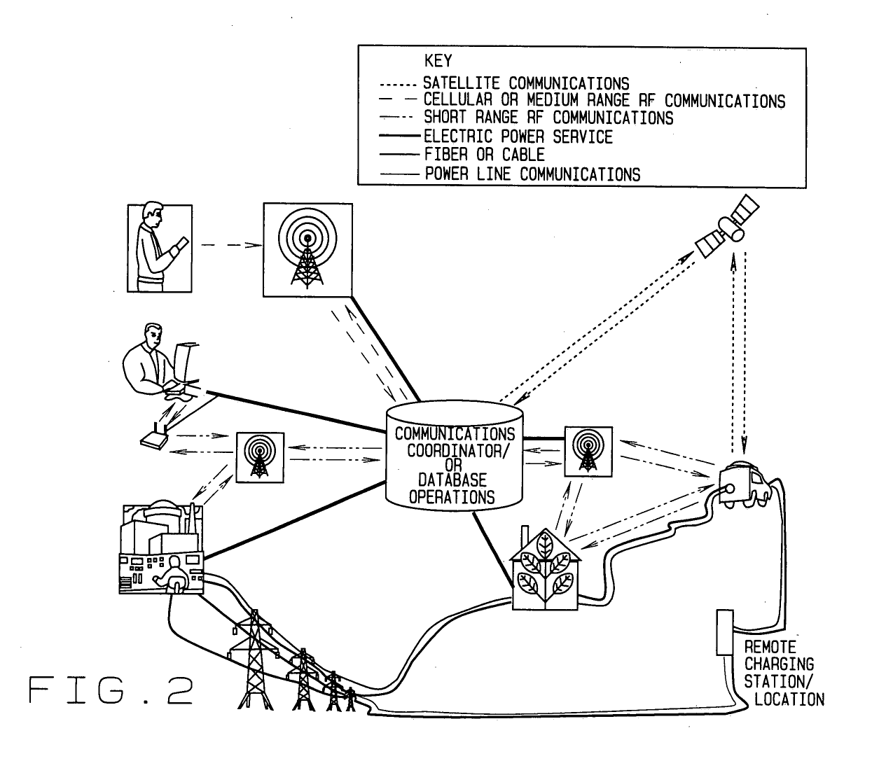

### DESCRIPTION OF THE PREFERRED EMBODIMENT

The new method of the Energy Management System disclosed herein will allow the end user/consumer to set a minimum reserve charge for an Energy Storage Device so that the primary purpose can be accomplished before the Smart Grid will be allowed to extract stored energy, and will prevent excessive discharge that would damage the Energy Storage Device. Such minimum reserve charge can be either a static or variable level, depending upon the anticipated needs of the primary purpose. The minimum reserve charge can be remotely adjusted to account for changes in anticipated needs.

The invention overcomes the limitations and weaknesses of the current art through the following:

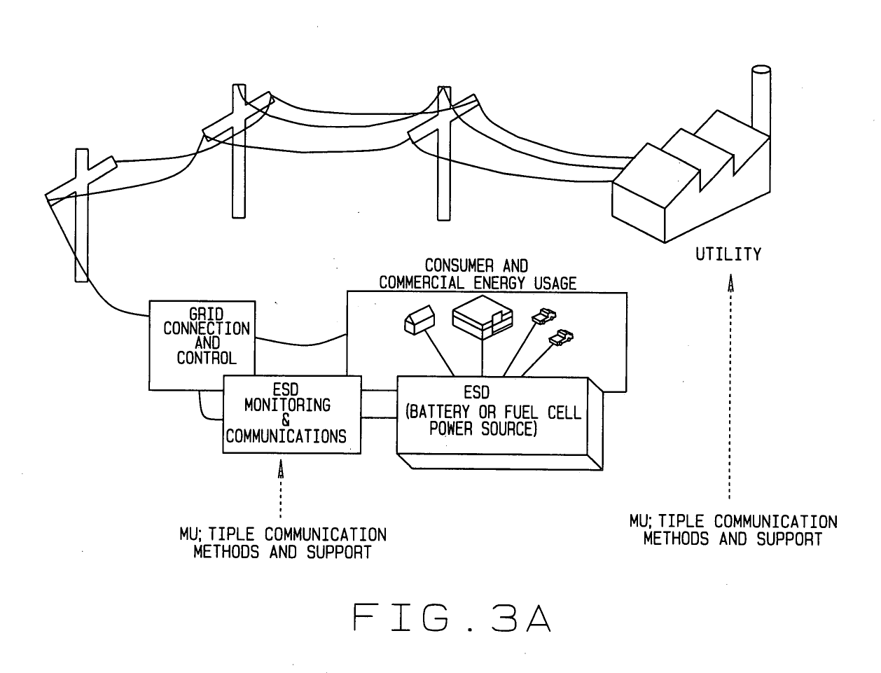

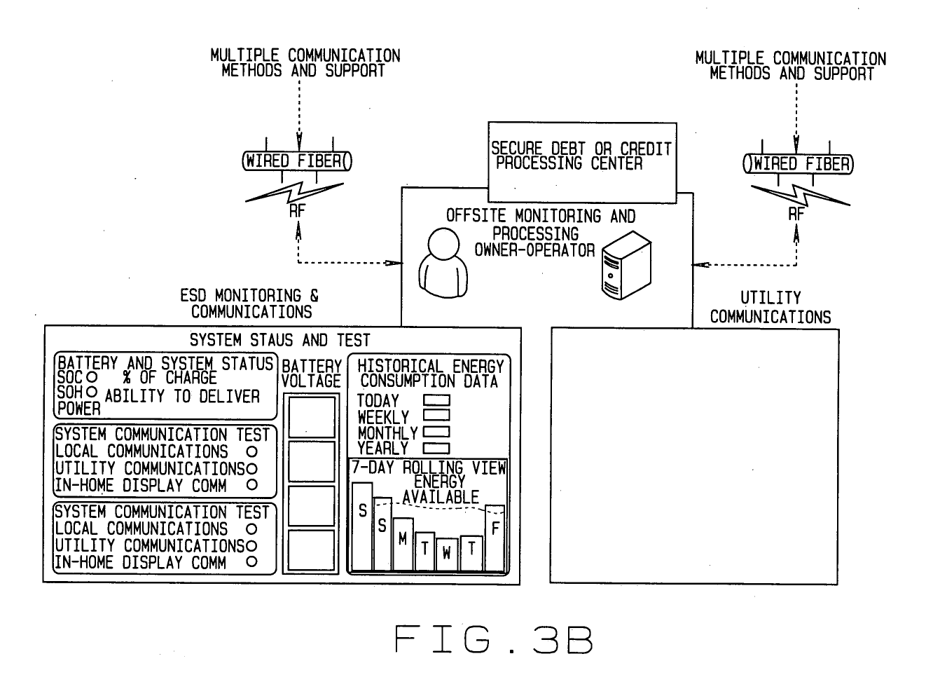

The Energy Management System (the “system”) FIG. 3 will include and/or interface with a two way communications device, said communication device enabling the flow of information both to and from external entities. External entities shall include, without limitation, authorized databases (including third party databases) and the owner/operator of the Energy Storage Device. The preferred mode of communication will be satellite, but may also include (a) cellular or (b) the communications medium(s) utilized in a two way AMI system employed in the primary service territory.

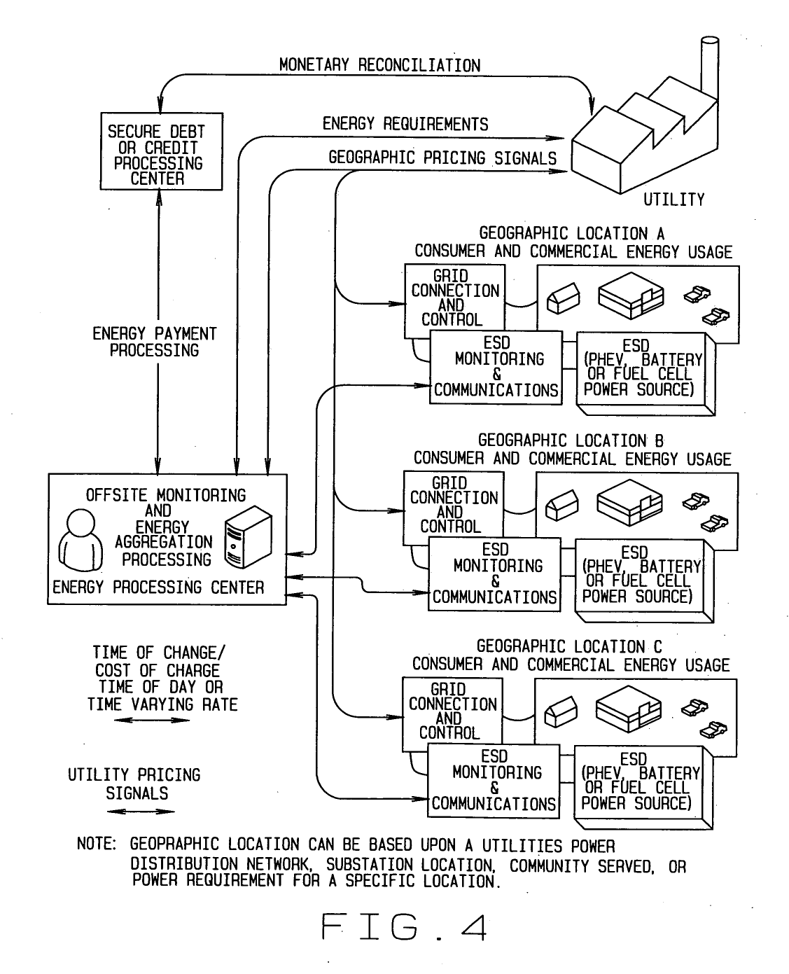

The system will consist of an Energy Management/Storage System that will further consist of a microprocessor or micro-controller as outlined in FIG. 4. Collectively, the system will process inputs received from a plurality of sources, including (a) a rate quote or rate schedule (FIG. 4, A1/A2) (based upon time of charge) from a provider of an electric charge (e.g., a primary utility or a third party charging facility (such as an enabled parking garage)), (b) ambient readings from adjoining sensors (FIG. 4, A6) (c) requests from a provider of an electric charge to discharge energy in support of a Smart Grid demand event (FIG. 4, A1/A2) (d) instructions from the owner/operator of the Energy Storage Device (FIG. 4, A1/A2), establishing a profile (FIG. 4, A4) (that may be edited), that will include the establishment of a minimum energy reserve (FIG. 4, A5) (which may be based upon the ESD manufacturer's specifications), and may further include variable reserve set points governed by expected power needs (i) in the case of a fixed ESD, to provide power in support of designated equipment (which may include an EV or PHEV) or appliances (ii) in the case of a mobile ESD (which includes an EV or PHEV), to provide power based upon an expected load plus an incremental reserve to account for deviations in anticipated demand; (e) instructions from the owner/operator via user interface (FIG. 4, A4) that excess energy may be discharged in response to a request relating to a Smart Grid demand event (f) data from authorized databases (FIG. 4, A1/A2/A5) that provides owner/operator information deemed necessary to accurately forecast the desired level of energy reserve (in the case of an EV or a PHEV, to include mapping programs that calculate mileage associated with either recommended or owner/operator defined routes) (g) data from authorized databases containing forecast information (such as weather predictions, expected traffic conditions, detours, roadway grades, etc.). The determination of the necessary reserve may also consider analyses of auxiliary power available from supplemental sources (e.g., solar, wind, other renewable sources of distributed generation, combustion engines) based upon deterministic models.

The system will consist of an Energy Management/Storage System that will further consist of a microprocessor or micro-controller as outlined in FIG. 4. Collectively the system will provide outputs (FIG. 4, A2) that will include (a) control of the inverter or other device(s) that allows for charging or discharging of the Energy Storage Device, and commands to engage the inverter or other device to effect the desired level of energy reserve (b) messaging that includes (i) notification to a provider of an electric charge (FIG. 4, A1/A2) that the ESD has excess energy that may be available for discharge onto the system, including specifications as to the current, voltage, etc. available (ii) notification to the provider of an electric charge that the ESD will require an amount of charge, including specifications as to the current, voltage, etc. required (iii) notification to the owner/operator via communications (FIG. 4, A1/A2) or user interface (FIG. 4, A4) of the ESD that (1) a charge is necessary (2) charging has reached the prescribed set point (or interim measures of the prescribed set point) (3) confirmation that a new set point via (FIG. 4, A1/A2/A4), if any, has been entered into the Energy Management System (4) alarm notification if a charge has been prematurely terminated via system I/O (FIG. 4, A5) (5) notification if the rate schedule for charging is outside of a predetermined range of acceptability, as dictated by the owner/operator profile described at 2(d) above (iv) notification that a Smart Grid demand event is occurring and that a request has been made for a discharge from the ESD. Notification to the owner/operator of the ESD that (1) a charge is necessary (2) charging has reached the prescribed set point (or interim measures of the prescribed set point) (3) confirmation that a new set point, if any, has been entered into the Energy Management System (4) alarm notification if a charge has been prematurely terminated (5) notification if the rate schedule for charging is outside of a predetermined range of acceptability, as dictated by the owner/operator profile described at 2(b) above (iv) notification that a Smart Grid demand even is occurring and that a request has been made for a discharge from the ESD.

The system, consisting of a microprocessor or micro-controller as outlined in FIG. 4 will assess the inputs and outputs with the appropriate firmware (FIG. 4, A3) to analyze and determine (i) the amount of energy required to satisfy the desired reserve (ii) the amount of energy in storage in excess of the desired reserve that is available for discharge in the event of a Smart Grid demand event (iii) the specifications of the charge either required or available for discharge (e.g., voltage, current, etc.) (iv) that a messaging event has occurred that must be acted upon. Data analysis, system usage, various selected alarms, and data set points will be stored in the appropriate database (FIG. 4, A4/A5) and will utilize communications (FIG. 4, A1/A2) making the embedded firmware or software (FIG. 4, A3) analysis made available to owner, operator, utility, power provider, ISO, demand aggregator, or a localized energy management system.

The system will, based upon the analytics described in item 4 using embedded firmware or resident software (FIG. 4, A3) and, the instructions from the owner/operator (FIG. 4, A1/A2 or A4) and the profile (i) (FIG. 4, A4/A5) engage or disengage the inverter or other controlling device to either charge or terminate a charging session, or to discharge or terminate a discharge session (ii) issue a secure message to the owner/operator, or other authorized third party, of any alarm, demand event, charging status notification and confirmation notices indicating that commands have been carried out in accordance with instructions; notifications may also include notices of changes to rates or rate schedules received by the Energy Management System and made available to the user owner by a suitable user interface (FIG. 4, A4).

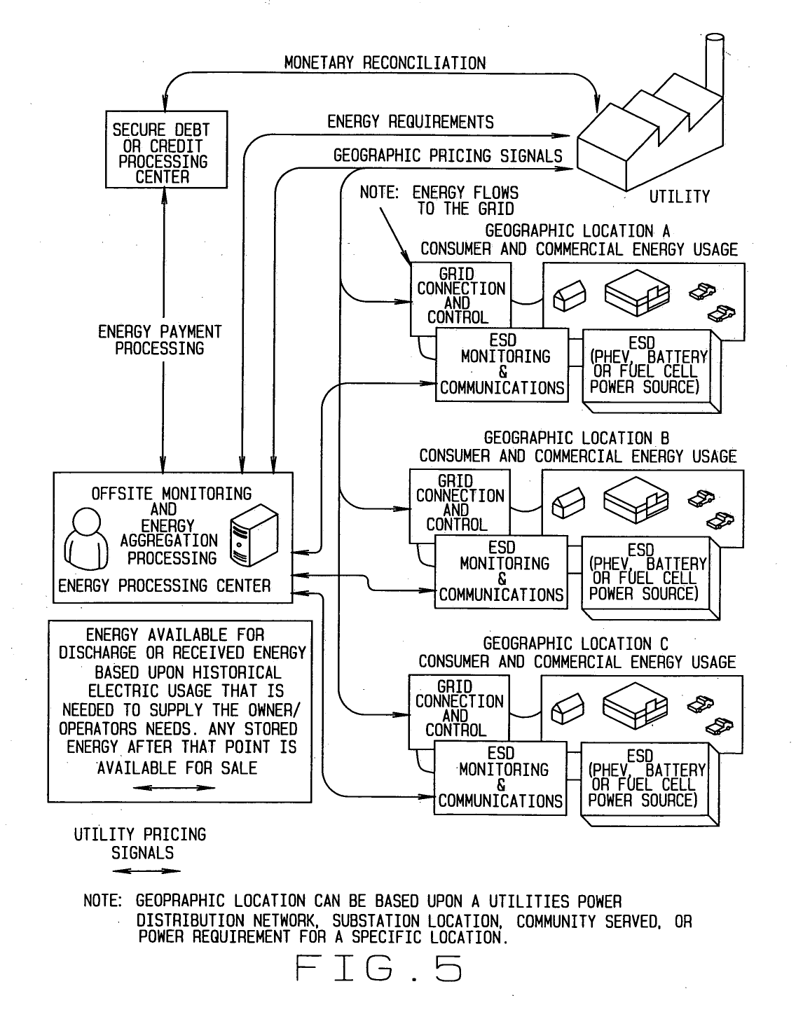

A database will collect information communicated from individual systems via the two-way communications medium, as described in item 1 above, so that information on energy flow requirements or availability (charge or discharge attributes) on a given circuit or feeder may be aggregated for Smart Grid planning purposes. The aggregated energy may be a result of energy purchased or supplied depending on the owner-operator preference as based on buy-sell criteria FIG. 5 that best fits the needs of the owner-operator. Note that the owner-operator maybe an individual PHEV owner, demand-side aggregator, or the utility itself.

The features of the Energy Management System will allow individual consumers to participate in time of use or critical peak pricing programs in a manner that maximizes the overall efficiency of the Smart Grid, ensures consumers that energy is available for planned usage requirements, and provides overall societal benefits through minimization of emissions and waste.

Variations or modifications to the subject matter of this invention may occur to those skilled in the art upon reviewing the development as described herein. Such variations, if within the scope of this development, are intended to be encompassed within the principles of this invention, as explained herein. The description of the preferred embodiment, in addition to the depiction within the drawings, is set forth for illustrative purposes only.

1. A method of remotely controlling the level of charge or discharge of an energy storage device.

2. A method of claim 1 wherein the energy storage device will be controlled by an energy management system that is capable of determining a minimum level of required stored energy necessary to (a) maintain the health of the energy storage device and (b) to assure that the energy storage device has sufficient energy to support its primary load.

3. A method of claim 1 wherein a either a single or multiple communications protocols or technologies may be utilized to send or receive information or control commands between the energy management system and a remotely located owner or authorized user.

4. A method of claim 2 wherein the owner or authorized user establishes prices at which charging or discharging is allowed to occur, including variable prices that may be acceptable for accelerated charging.

5. A method of claim 2 wherein the determination of the minimum level of required stored energy is based upon an algorithm, or algorithms, that make use of energy storage device parameters that have been collected in a database or are available in a memory storage device.

6. A method of claim 5 wherein at least one parameter considered by the algorithm is comprised of the Global Positioning System location coordinates of the energy storage device.

7. A method of claim 5 wherein if the energy storage device has a primary purpose of supporting a mobile asset, then another parameter considered by the algorithm is comprised of the Global Positioning System location coordinates at the destination where the energy storage device will be expected to obtain its subsequent charge, along with the intermediate slope characteristics of the route.

8. A method of claim 7 wherein the energy management system may recommend the most energy efficient route for the energy storage device to arrive at its destination.

9. A method of claim 5 wherein the algorithm(s) may consider the chemical composition of the energy storage device, current and anticipated ambient conditions surrounding the energy storage device and load variables (both in terms of electric loads or physical weight) that might reasonably be expected to affect the required level of energy storage.

10. A method of claim 5 wherein ambient conditions, road or traffic conditions, or other relevant variables may be transmitted to the Energy Management System from a remote location, including a central processing facility.

11. A method of claim 5 wherein the algorithm processing, the collection of data variables and the storage of historical information occurs at a central processing and data storage facility.

12. A method of determining the aggregate amount of energy that must be delivered within a geographic territory in order to satisfy the requirements of the energy management systems that report individual requirements within such territory.

13. A method of claim 12 wherein the aggregate energy requirements within the defined territory are further categorized or grouped based upon two or more respective bid or auction prices.

14. A method of claim 12 wherein the energy requirements are determined at a central processing and data storage facility.

15. A method of claim 14 wherein the energy requirement determinations are communicated to geographically local energy service providers that subscribe to receive such information.

16. A method of determining the aggregate amount of energy that is available for delivery via discharge from individual energy storage devices within a geographic territory based upon communications with the energy management systems that report individual discharge availability within such territory.

17. A method of claim 16 wherein the aggregate energy available for discharge within the defined territory is further categorized or grouped based upon two or more respective bid or auction prices.

18. A method of claim 16 wherein the aggregate amount of energy available for discharge to the grid, or an intermediate storage device, is determined at a central processing and data storage facility.

19. A method of claim 17 wherein the aggregate amount of energy available for discharge to the grid, or an intermediate storage device, is communicated to the geographically local energy service providers that subscribe to receive such information.

20. A method of claims 4, 12 and 16, wherein the central processing and data storage facility will act as a clearinghouse for transactions to sell and buy energy at rates that are negotiated between the energy management device and the energy provider.

21. A method of claim 19 wherein the clearinghouse process utilizes a system of secure debit card or credit card processing.

22. A method of reconciling energy transactions, wherein the energy management system contains necessary account credentials and communications those credentials to as secured charging facility or its related control center, such that a transaction is initiated that will enable charges or credits to be posted to an authorized debit or credit account.
